(19) United States
(12) Patent Application Publication
(10) Pub. No.: US 2025/0343286 A1
(43) Pub. Date: Nov. 6, 2025

(54) BATTERY MAINTENANCE AND MANAGEMENT SYSTEM FOR A VOCATIONAL VEHICLE

(71) Applicant: Oshkosh Corporation, Oshkosh, WI (US)

(72) Inventor: Jeff Verhagen, Oshkosh, WI (US)

(73) Assignee: Oshkosh Corporation, Oshkosh, WI (US)

(21) Appl. No.: 19/197,900

(22) Filed: May 2, 2025

Related U.S. Application Data
(60) Provisional application No. 63/642,076, filed on May 3, 2024.

(51) Int. Cl. H01M 10/42; B60R 16/033; B65F 3/02; B65F 3/04; B65F 3/20; H01M 10/46; H01M 16/00; H02J 7/00

(52) U.S. Cl. CPC H01M 10/425; B60R 16/033; B65F 3/04; B65F 3/20; H01M 10/46; H01M 16/006; H02J 7/0048; B65F 2003/0269; B65F 2003/0283; H01M 2010/4271; H01M 2220/20; H01M 2250/20; H01M 2250/402

(57) ABSTRACT

A battery management system includes a battery pack and a controller in communication with the battery pack and a packing actuator of the refuse vehicle. The controller is configured to receive a state of charge of the battery pack, determine if the state of charge satisfies a lower threshold, in response to determining that the state of charge satisfies the lower threshold, prevent operation of the packing actuator, determine if the state of charge satisfies an upper threshold, and in response to determining that the state of charge satisfies the upper threshold, initiate operation of the packing actuator.

### CROSS-REFERENCE TO RELATED PATENT APPLICATIONS

This application claims the benefit of and priority to U.S. Provisional Application No. 63/642,076, filed on May 3, 2024, the entire disclosure of which is hereby incorporated by reference herein.

### BACKGROUND

Refuse vehicles collect a wide variety of waste, trash, and other material from residences and businesses. Operators of the refuse vehicles transport the material from various waste receptacles within a municipality to a storage or processing facility (e.g., a landfill, an incineration facility, a recycling facility, etc.).

### SUMMARY

In some aspects, the present disclosure relates to a battery management system for a refuse vehicle, including: a battery pack; and a controller in communication with the battery pack and a packing actuator of the refuse vehicle, wherein the controller is configured to: receive a state of charge of the battery pack; determine if the state of charge satisfies a lower threshold; in response to determining that the state of charge satisfies the lower threshold, prevent operation of the packing actuator; determine if the state of charge satisfies an upper threshold; and in response to determining that the state of charge satisfies the upper threshold, initiate operation of the packing actuator.

In some aspects, the present disclosure relates to a battery management system for a refuse vehicle, including: a battery pack; and a controller in communication with the battery pack, wherein the controller is configured to: receive a state of charge of the battery pack; determine if the state of charge satisfies a lower threshold; in response to determining that the state of charge satisfies the lower threshold, initiate a charging procedure for the battery pack and limit function operation for the refuse vehicle; determine if the state of charge satisfies an upper threshold; and in response to determining that the state of charge satisfies the upper threshold, initiate a discharge procedure for the battery pack.

In some aspects, the present disclosure relates to a refuse vehicle including: a chassis; a refuse compartment supported on the chassis; a lift assembly; a packing actuator movable between a retracted position and an extended position; a battery pack; and a controller in communication with the battery pack, the lift assembly, and the packing actuator, wherein the controller is configured to: receive a state of charge of the battery pack; determine if the state of charge satisfies a lower threshold; in response to determining that the state of charge satisfies the lower threshold, prevent operation of the packing actuator; determine if the state of charge satisfies an upper threshold; and in response to determining that the state of charge satisfies the upper threshold, initiate operation of the packing actuator.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a left side view of a vehicle, according to an exemplary embodiment;

FIG. 2 is a perspective view of a chassis of the vehicle of FIG. 1;

FIG. 3 is a perspective view of the vehicle of FIG. 1 configured as a front-loading refuse vehicle, according to an exemplary embodiment;

FIG. 4 is a left side view of the front-loading refuse vehicle of FIG. 3 configured with a tag axle;

FIG. 5 is a perspective view of the vehicle of FIG. 1 configured as a side-loading refuse vehicle, according to an exemplary embodiment;

FIG. 6 is a right side view of the side-loading refuse vehicle of FIG. 5;

FIG. 7 is a top view of the side-loading refuse vehicle of FIG. 5;

FIG. 8 is a left side view of the side-loading refuse vehicle of FIG. 5 configured with a tag axle;

FIG. 9 is a perspective view of a refuse compartment and hopper volume of a refuse vehicle, according to an exemplary embodiment.

FIG. 10 is a perspective view of the refuse compartment and the hopper volume of FIG. 9 with a pack panel at least partially extended, according to an exemplary embodiment;

FIG. 11 is a cross-sectional view of a refuse compartment and a packing assembly of a refuse vehicle, with a pack panel in a retracted position, according to an exemplary embodiment;

FIG. 12 is a cross-sectional view of a refuse compartment and a packing assembly of the refuse vehicle of FIG. 11, with a pack panel extended between a retracted position and an extended position, according to an exemplary embodiment;

FIG. 13 is a cross-sectional view of a refuse compartment and a packing assembly of the refuse vehicle of FIG. 11, with a pack panel in an extended position, according to an exemplary embodiment;

FIG. 14 is a schematic illustration of an E-PTO system of a refuse vehicle, according to an exemplary embodiment;

FIG. 15 is a schematic illustration of a control system of a refuse vehicle, according to an exemplary embodiment; and

FIG. 16 is a flow chart illustrating the steps in a battery management method or process, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

According to an exemplary embodiment a battery management system for a refuse vehicle includes a battery pack having one or more batteries. The battery management system also includes a controller in communication with the battery pack and one or more components of the refuse vehicle. The battery controller is configured to receive an input from the battery pack, the input including a state of charge of the battery pack. The battery controller is further configured to process the input from the battery pack, and generate, in response to the input from the battery pack, one or more controls relating to operation of the one or more components of the refuse vehicle, and send the one or more controls to the one or more components of the refuse vehicle.

In general, the battery management system is configured to selectively control operation of one or more components on the refuse vehicle to maintain a state of charge of the battery pack within a desired operating range. If the state of charge satisfies a lower threshold, the controller is configured to initiate a charge procedure (e.g., convert on-board fuel into electrical energy to charge the battery pack) and/or limit operation of battery-powered components/functions on the refuse vehicle (e.g., prevent a packing actuator from operating). If the state of charge satisfies an upper threshold, the controller is configured to initiate a discharge procedure (e.g., initiate a packing process where a packing actuator actuates from a retracted position to a packing position and back to the retracted position). In this way, for example, the controller is configured to maintain the state of charge of the battery pack within the desired operating range to improve battery operating efficiency and increase the operating life of the battery pack.

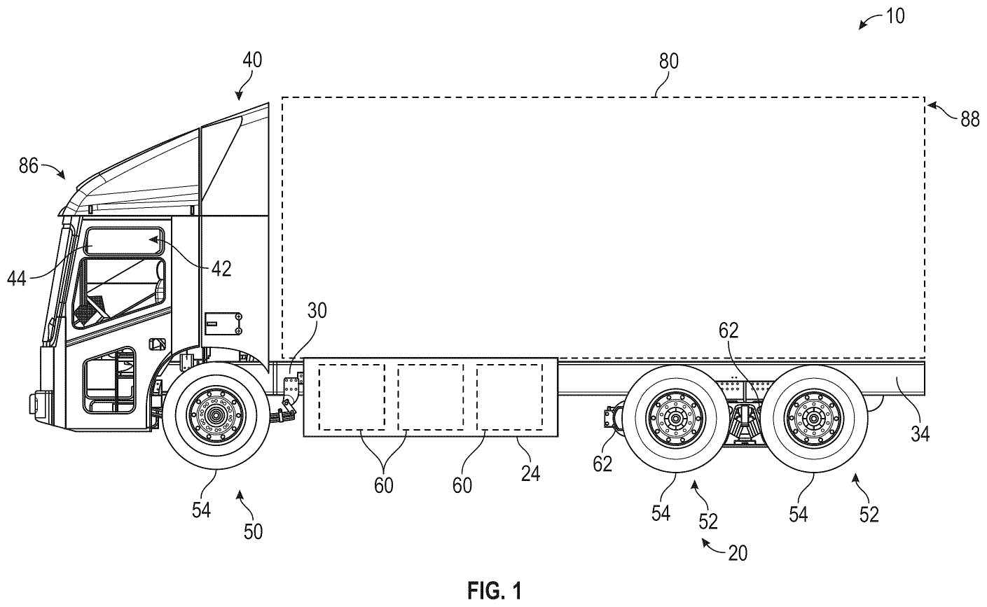

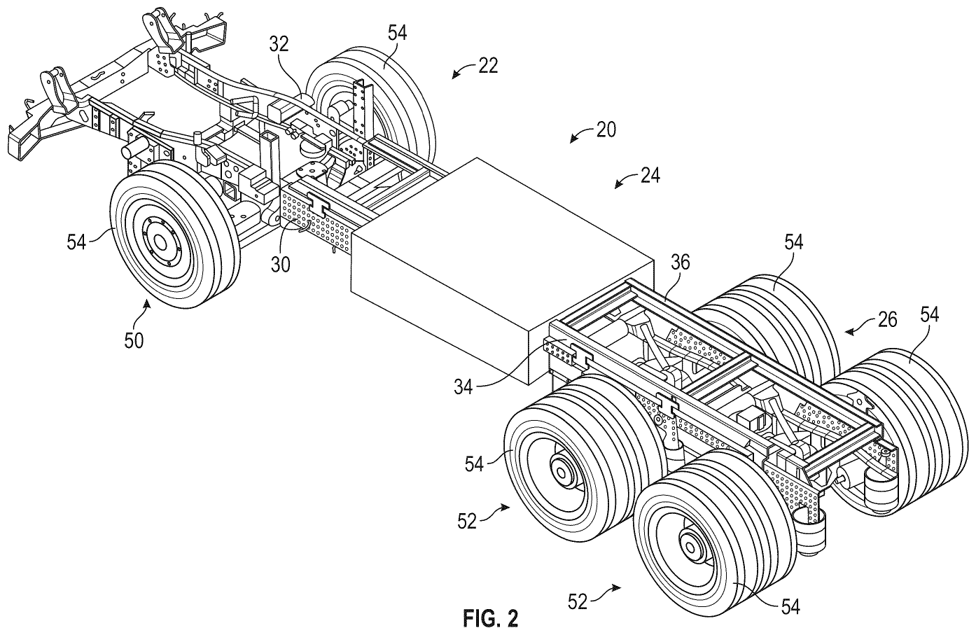

Referring to FIGS. 1 and 2, a reconfigurable vehicle (e.g., a vehicle assembly, a vocational vehicle, a truck, a vehicle base, etc.) is shown as vehicle 10, according to an exemplary embodiment. As shown, the vehicle 10 includes a frame assembly or chassis assembly, shown as chassis 20, that supports other components of the vehicle 10. The chassis 20 extends longitudinally along a length of the vehicle 10, substantially parallel to a primary direction of travel of the vehicle 10. As shown, the chassis 20 includes three sections or portions, shown as front section 22, middle section 24, and rear section 26. The middle section 24 of the chassis 20 extends between the front section 22 and the rear section 26. In some embodiments, the middle section 24 of the chassis 20 couples the front section 22 to the rear section 26. In other embodiments, the front section 22 is coupled to the rear section 26 by another component (e.g., the body of the vehicle 10).

As shown in FIG. 2, the front section 22 includes a pair of frame portions, frame members, or frame rails, shown as front rail portion 30 and front rail portion 32. The rear section 26 includes a pair of frame portions, frame members, or frame rails, shown as rear rail portion 34 and rear rail portion 36. The front rail portion 30 is laterally offset from the front rail portion 32. Similarly, the rear rail portion 34 is laterally offset from the rear rail portion 36. This spacing may provide frame stiffness and space for vehicle components (e.g., batteries, motors, axles, gears, etc.) between the frame rails. In some embodiments, the front rail portions 30 and 32 and the rear rail portions 34 and 36 extend longitudinally and substantially parallel to one another. The chassis 20 may include additional structural elements (e.g., cross members that extend between and couple the frame rails).

In some embodiments, the front section 22 and the rear section 26 are configured as separate, discrete subframes (e.g., a front subframe and a rear subframe). In such embodiments, the front rail portion 30, the front rail portion 32, the rear rail portion 34, and the rear rail portion 36 are separate, discrete frame rails that are spaced apart from one another. In some embodiments, the front section 22 and the rear section 26 are each directly coupled to the middle section 24 such that the middle section 24 couples the front section 22 to the rear section 26. Accordingly, the middle section 24 may include a structural housing or frame. In other embodiments, the front section 22, the middle section 24, and the rear section 26 are coupled to one another by another component, such as a body of the vehicle 10.

In other embodiments, the front section 22, the middle section 24, and the rear section 26 are defined by a pair of frame rails that extend continuously along the entire length of the vehicle 10. In such an embodiment, the front rail portion 30 and the rear rail portion 34 would be front and rear portions of a first frame rail, and the front rail portion 32 and the rear rail portion 36 would be front and rear portions of a second frame rail. In such embodiments, the middle section 24 would include a center portion of each frame rail.

In some embodiments, the middle section 24 acts as a storage portion that includes one or more vehicle components. The middle section 24 may include an enclosure that contains one or more vehicle components and/or a frame that supports one or more vehicle components. By way of example, the middle section 24 may contain or include one or more electrical energy storage devices (e.g., batteries, capacitors, etc.). By way of another example, the middle section 24 may include fuel tanks fuel tanks. By way of yet another example, the middle section 24 may define a void space or storage volume that can be filled by a user.

A cabin, operator compartment, or body component, shown as cab 40, is coupled to a front end portion of the chassis 20 (e.g., the front section 22 of the chassis 20). Together, the chassis 20 and the cab 40 define a front end of the vehicle 10. The cab 40 extends above the chassis 20. The cab 40 includes an enclosure or main body that defines an interior volume, shown as cab interior 42, that is sized to contain one or more operators. The cab 40 also includes one or more doors 44 that facilitate selective access to the cab interior 42 from outside of the vehicle 10. The cab interior 42 contains one or more components that facilitate operation of the vehicle 10 by the operator. By way of example, the cab interior 42 may contain components that facilitate operator comfort (e.g., seats, seatbelts, etc.), user interface components that receive inputs from the operators (e.g., steering wheels, pedals, touch screens, switches, buttons, levers, etc.), and/or user interface components that provide information to the operators (e.g., lights, gauges, speakers, etc.). The user interface components within the cab 40 may facilitate operator control over the drive components of the vehicle 10 and/or over any implements of the vehicle 10.

The vehicle 10 further includes a series of axle assemblies, shown as front axle 50 and rear axles 52. As shown, the vehicle 10 includes one front axle 50 coupled to the front section 22 of the chassis 20 and two rear axles 52 each coupled to the rear section 26 of the chassis 20. In other embodiments, the vehicle 10 includes more or fewer axles. By way of example, the vehicle 10 may include a tag axle that may be raised or lowered to accommodate variations in weight being carried by the vehicle 10. The front axle 50 and the rear axles 52 each include a series of tractive elements (e.g., wheels, treads, etc.), shown as wheel and tire assemblies 54. The wheel and tire assemblies 54 are configured to engage a support surface (e.g., roads, the ground, etc.) to support and propel the vehicle 10. The front axle 50 and the rear axles may include steering components (e.g., steering arms, steering actuators, etc.), suspension components (e.g., gas springs, dampeners, air springs, etc.), power transmission or drive components (e.g., differentials, drive shafts, etc.), braking components (e.g., brake actuators, brake pads, brake discs, brake drums, etc.), and/or other components that facilitate propulsion or support of the vehicle.

In some embodiments, the vehicle 10 is configured as an electric vehicle that is propelled by an electric powertrain system. Referring to FIG. 1, the vehicle 10 includes one or more electrical energy storage devices (e.g., batteries, battery pack, capacitors, etc.), shown as batteries 60. As shown, the batteries 60 are positioned within the middle section 24 of the chassis 20. In other embodiments, the batteries 60 are otherwise positioned throughout the vehicle 10. The vehicle 10 further includes one or more electromagnetic devices or prime movers (e.g., motor/generators), shown as drive motors 62. The drive motors 62 are electrically coupled to the batteries 60. The drive motors 62 may be configured to receive electrical energy from the batteries 60 and provide rotational mechanical energy to the wheel and tire assemblies 54 to propel the vehicle 10. The drive motors 62 may be configured to receive rotational mechanical energy from the wheel and tire assemblies 64 and provide electrical energy to the batteries 60, providing a braking force to slow the vehicle 10.

The batteries 60 may include one or more rechargeable batteries (e.g., lithium-ion batteries, nickel-metal hydride batteries, lithium-ion polymer batteries, lead-acid batteries, nickel-cadmium batteries, etc.). The batteries 60 may be charged by one or more sources of electrical energy onboard the vehicle 10 (e.g., solar panels, etc.) or separate from the vehicle 10 (e.g., connections to an electrical power grid, a wireless charging system, etc.). As shown, the drive motors 62 are positioned within the rear axles 52 (e.g., as part of a combined axle and motor assembly). In other embodiments, the drive motors 62 are otherwise positioned within the vehicle 10.

In some embodiments, the vehicle 10 is configured as a hybrid vehicle that is propelled by a hybrid powertrain system (e.g., a diesel/electric hybrid, gasoline/electric hybrid, natural gas/electric hybrid, fuel cell/electric, etc.). According to an exemplary embodiment, the hybrid powertrain system may include a primary driver (e.g., an engine, a motor, etc.), an energy generation device (e.g., a generator, a fuel cell, etc.), and/or an energy storage device (e.g., a battery, battery pack, capacitors, ultra-capacitors, etc.) electrically coupled to the energy generation device. The primary driver may combust fuel (e.g., gasoline, diesel, hydrogen, etc.) to provide mechanical energy, which a transmission may receive and provide to the axle front axle 50 and/or the rear axles 52 to propel the vehicle 10. Additionally or alternatively, the primary driver may provide mechanical energy to the generator, which converts the mechanical energy into electrical energy. The electrical energy may be stored in the energy storage device (e.g., the batteries 60) in order to later be provided to a motive driver.

In yet other embodiments, the chassis 20 may further be configured to support non-hybrid powertrains. For example, the powertrain system may include a primary driver that is a compression-ignition internal combustion engine that utilizes diesel fuel.

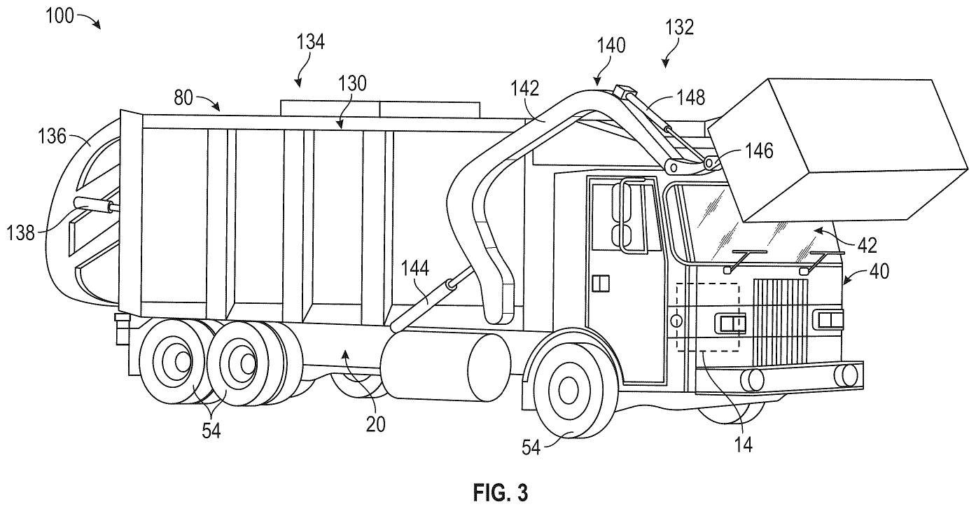

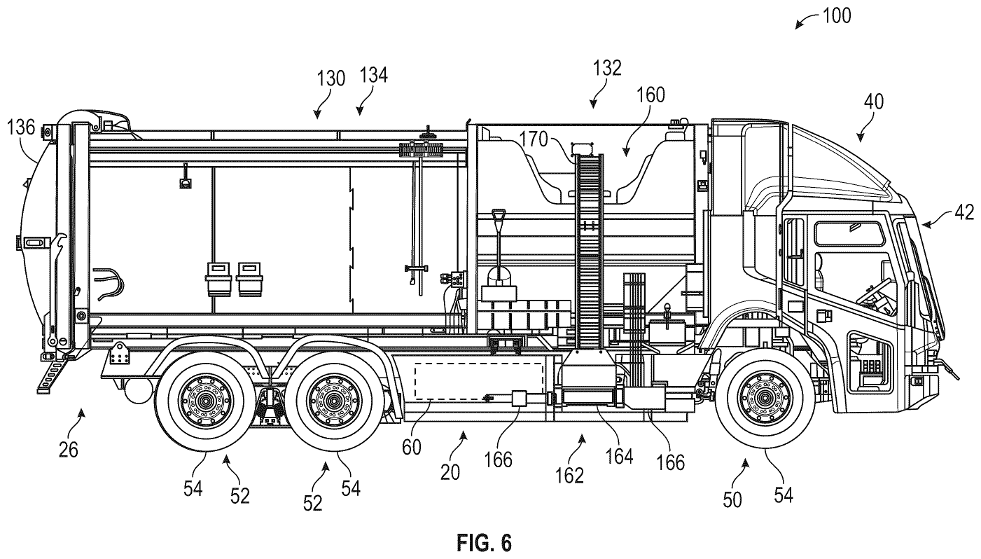

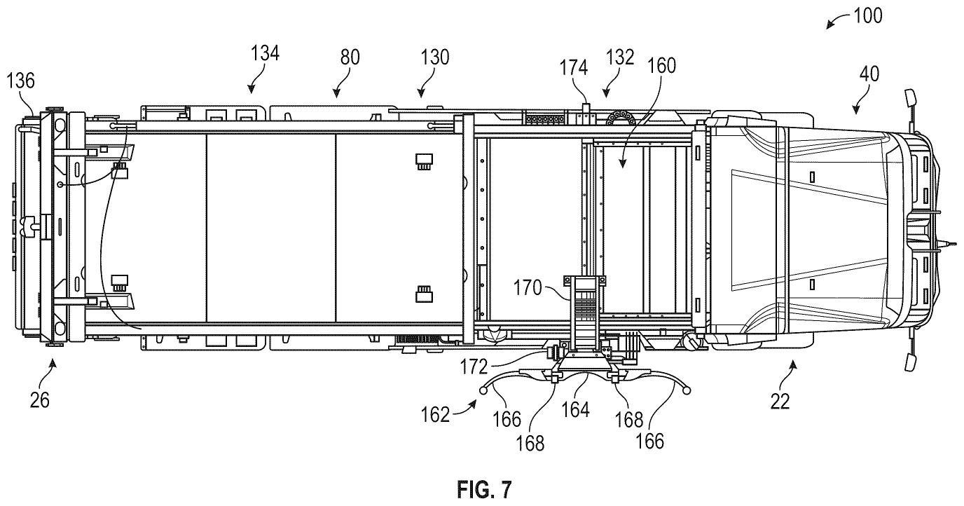

Referring to FIG. 1, the vehicle 10 includes a rear assembly, module, implement, body, or cargo area, shown as application kit 80. The application kit 80 may include one or more implements, vehicle bodies, and/or other components. Although the application kit 80 is shown positioned behind the cab 40, in other embodiments the application kit 80 extends forward of the cab 40. The vehicle 10 may be outfitted with a variety of different application kits 80 to configure the vehicle 10 for use in different applications. Accordingly, a common vehicle 10 can be configured for a variety of different uses simply by selecting an appropriate application kit 80. By way of example, the vehicle 10 may be configured as a refuse vehicle, a concrete mixer, a fire fighting vehicle, an airport fire fighting vehicle, a lift device (e.g., a boom lift, a scissor lift, a telchandler, a vertical lift, etc.), a crane, a tow truck, a military vehicle, a delivery vehicle, a mail vehicle, a boom truck, a plow truck, a farming machine or vehicle, a construction machine or vehicle, a coach bus, a school bus, a semi-truck, a passenger or work vehicle (e.g., a sedan, a SUV, a truck, a van, etc.), and/or still another vehicle. FIGS. 3-8 illustrate various examples of how the vehicle 10 may be configured for specific applications. Although only a certain set of vehicle configurations is shown, it should be understood that the vehicle 10 may be configured for use in other applications that are not shown.

The application kit 80 may include various actuators to facilitate certain functions of the vehicle 10. By way of example, the application kit 80 may include hydraulic actuators (e.g., hydraulic cylinders, hydraulic motors, etc.), pneumatic actuators (e.g., pneumatic cylinders, pneumatic motors, etc.), and/or electrical actuators (e.g., electric motors, electric linear actuators, etc.). The application kit 80 may include components that facilitate operation of and/or control of these actuators. By way of example, the application kit 80 may include hydraulic or pneumatic components that form a hydraulic or pneumatic circuit (e.g., conduits, valves, pumps, compressors, gauges, reservoirs, accumulators, etc.). By way of another example, the application kit 80 may include electrical components (e.g., batteries, capacitors, voltage regulators, motor controllers, etc.). The actuators may be powered by components of the vehicle 10. By way of example, the actuators may be powered by the batteries 60, the drive motors 62, or the primary driver (e.g., through a power take off).

The vehicle 10 generally extends longitudinally from a front side 86 to a rear side 88. The front side 86 is defined by the cab 40 and/or the chassis. The rear side 88 is defined by the application kit 80 and/or the chassis 20. The primary, forward direction of travel of the vehicle 10 is longitudinal, with the front side 86 being arranged forward of the rear side 88.

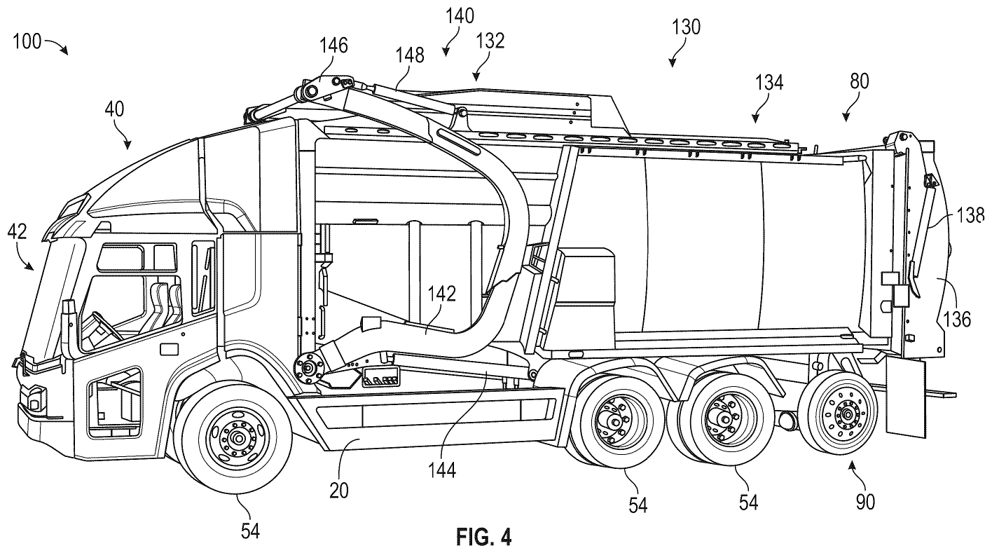

Referring now to FIGS. 3 and 4, the vehicle 10 is configured as a refuse vehicle 100 (e.g., a refuse truck, a garbage truck, a waste collection truck, a sanitation truck, a recycling truck, etc.). Specifically, the refuse vehicle 100 is a front-loading refuse vehicle. In other embodiments, the refuse vehicle 100 is configured as a rear-loading refuse vehicle or a front-loading refuse vehicle. The refuse vehicle 100 may be configured to transport refuse from various waste receptacles (e.g., refuse containers) within a municipality to a storage and/or processing facility (e.g., a landfill, an incineration facility, a recycling facility, etc.).

FIG. 4 illustrates the refuse vehicle 100 of FIG. 3 configured with a liftable axle, shown as tag axle 90, including a pair of wheel and tire assemblies 54. As shown, the tag axle 90 is positioned reward of the rear axles 52. The tag axle 90 can be selectively raised and lowered (e.g., by a hydraulic actuator) to selectively engage the wheel and tire assemblies 54 of the tag axle 90 with the ground. The tag axle 90 may be raised to reduce rolling resistance experienced by the refuse vehicle 100. The tag axle 90 may be lowered to distribute the loaded weight of the vehicle 100 across a greater number of a wheel and tire assemblies 54 (e.g., when the refuse vehicle 100 is loaded with refuse).

As shown in FIGS. 3 and 4, the application kit 80 of the refuse vehicle 100 includes a series of panels that form a rear body or container, shown as refuse compartment 130. The refuse compartment 130 may facilitate transporting refuse from various waste receptacles within a municipality to a storage and/or a processing facility (e.g., a landfill, an incineration facility, a recycling facility, etc.). By way of example, loose refuse may be placed into the refuse compartment 130 where it may be compacted (e.g., by a packer system within the refuse compartment 130). The refuse compartment 130 may also provide temporary storage for refuse during transport to a waste disposal site and/or a recycling facility. In some embodiments, the refuse compartment 130 may define a hopper volume 132 and storage volume 134. In this regard, refuse may be initially loaded into the hopper volume 132 and later compacted into the storage volume 134. As shown, the hopper volume 132 is positioned between the storage volume 134 and the cab 40 (e.g., refuse is loaded into a portion of the refuse compartment 130 behind the cab 40 and stored in a portion further toward the rear of the refuse compartment 130). In other embodiments, the storage volume may be positioned between the hopper volume and the cab 40 (e.g., in a rear-loading refuse truck, etc.). The application kit 80 of the refuse vehicle 100 further includes a pivotable rear portion, shown as tailgate 136, that is pivotally coupled to the refuse compartment 130. The tailgate 136 may be selectively repositionable between a closed position and an open position by an actuator (e.g., a hydraulic cylinder, an electric linear actuator, etc.), shown as tailgate actuator 138 (e.g., to facilitate emptying the storage volume).

As shown in FIGS. 3 and 4, the refuse vehicle 100 also includes an implement, shown as lift assembly 140, which is a front-loading lift assembly. According to an exemplary embodiment, the lift assembly 140 includes a pair of lift arms 142 and a pair of actuators (e.g., hydraulic cylinders, electric linear actuators, etc.), shown as lift arm actuators 144. The lift arms 142 may be rotatably coupled to the chassis 20 and/or the refuse compartment 130 on each side of the refuse vehicle 100 (e.g., through a pivot, a lug, a shaft, etc.), such that the lift assembly 140 may extend forward relative to the cab 40 (e.g., a front-loading refuse truck, etc.). In other embodiments, the lift assembly 140 may extend rearward relative to the application kit 80 (e.g., a rear-loading refuse truck). As shown in FIGS. 3 and 4, in an exemplary embodiment the lift arm actuators 144 may be positioned such that extension and retraction of the lift arm actuators 144 rotates the lift arms 142 about an axis extending through the pivot. In this regard, the lift arms 142 may be rotated by the lift arm actuators 144 to lift a refuse container over the cab 40. The lift assembly 140 further includes a pair of interface members, shown as lift forks 146, each pivotally coupled to a distal end of one of the lift arms 142. The lift forks 146 may be configured to engage a refuse container (e.g., a dumpster) to selectively coupled the refuse container to the lift arms 142. By way of example, each of the lift forks 146 may be received within a corresponding pocket defined by the refuse container. A pair of actuators (e.g., hydraulic cylinders, electric linear actuators, etc.), shown as articulation actuators 148, are each coupled to one of the lift arms 142 and one of the lift forks 146. The articulation actuators 148 may be positioned to rotate the lift forks 146 relative to the lift arms 142 about a horizontal axis. Accordingly, the articulation actuators 148 may assist in tipping refuse out of the refuse container and into the refuse compartment 130. The lift arm actuators 144 may then rotate the lift arms 142 to return the empty refuse container to the ground.

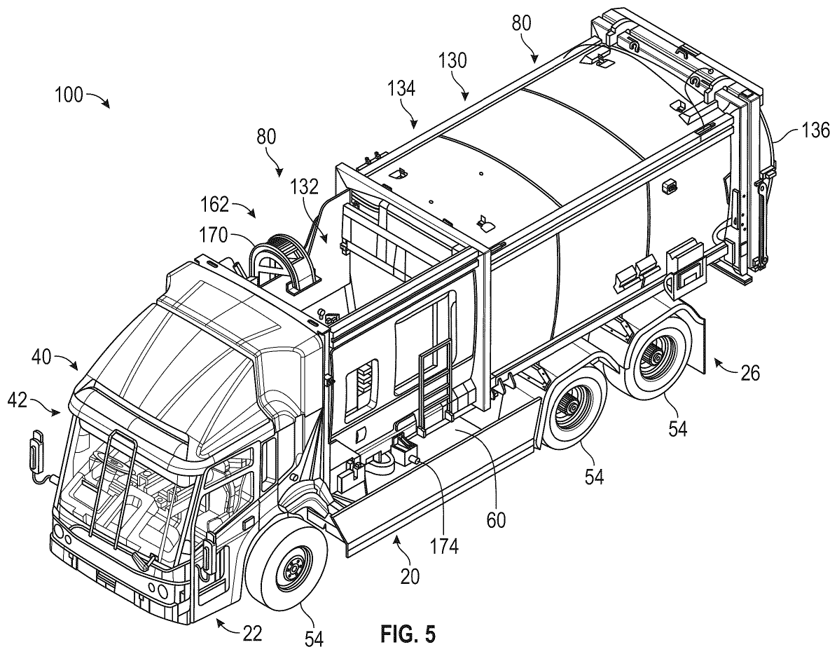

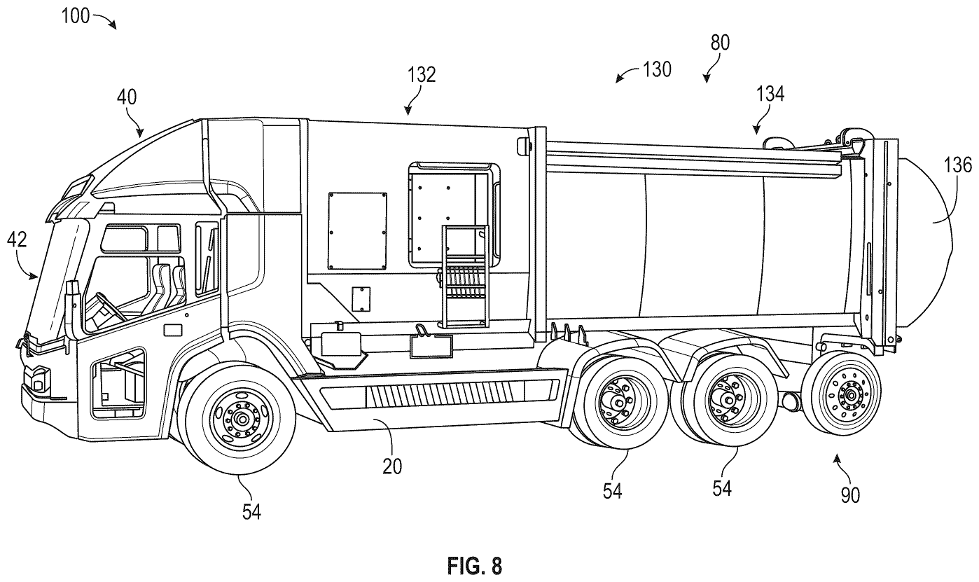

Referring now to FIGS. 5-8, an alternative configuration of the refuse vehicle 100 is shown according to an exemplary embodiment. Specifically, the refuse vehicle 100 of FIGS. 5-8 is configured as a side-loading refuse vehicle. The refuse vehicle 100 of FIGS. 5-8 may be substantially similar to the front-loading refuse vehicle 100 of FIGS. 3 and 4 except as otherwise specified herein. As shown, the refuse vehicle 100 of FIGS. 5-7 is configured with a tag axle 90 in FIG. 8.

Referring still to FIGS. 5-8, the refuse vehicle 100 omits the lift assembly 140 and instead includes a side-loading lift assembly, shown as lift assembly 160, that extends laterally outward from a side of the refuse vehicle 100. The lift assembly 160 includes an interface assembly, shown as grabber assembly 162, that is configured to engage a refuse container (e.g., a residential garbage can) to selectively couple the refuse container to the lift assembly 160. The grabber assembly 162 includes a main portion, shown as main body 164, and a pair of fingers or interface members, shown as grabber fingers 166. The grabber fingers 166 are pivotally coupled to the main body 164 such that the grabber fingers 166 are each rotatable about a vertical axis. A pair of actuators (e.g., hydraulic motors, electric motors, etc.), shown as finger actuators 168, are configured to control movement of the grabber fingers 166 relative to the main body 164.

The grabber assembly 162 is movably coupled to a guide, shown as track 170, that extends vertically along a side of the refuse vehicle 100. Specifically, the main body 164 is slidably coupled to the track 170 such that the main body 164 is repositionable along a length of the track 170. An actuator (e.g., a hydraulic motor, an electric motor, etc.), shown as lift actuator 172, is configured to control movement of the grabber assembly 162 along the length of the track 170. In some embodiments, a bottom end portion of the track 170 is straight and substantially vertical such that the grabber assembly 162 raises or lowers a refuse container when moving along the bottom end portion of the track 170. In some embodiments, a top end portion of the track 170 is curved such that the grabber assembly 162 inverts a refuse container to dump refuse into the hopper volume 132 when moving along the top end portion of the track 170.

The lift assembly 160 further includes an actuator (e.g., a hydraulic cylinder, an electric linear actuator, etc.), shown as track actuator 174, that is configured to control lateral movement of the grabber assembly 162. By way of example, the track actuator 174 may be coupled to the chassis 20 and the track 170 such that the track actuator 174 moves the track 170 and the grabber assembly 162 laterally relative to the chassis 20. The track actuator 174 may facilitate repositioning the grabber assembly 162 to pick up and replace refuse containers that are spaced laterally outward from the refuse vehicle 100.

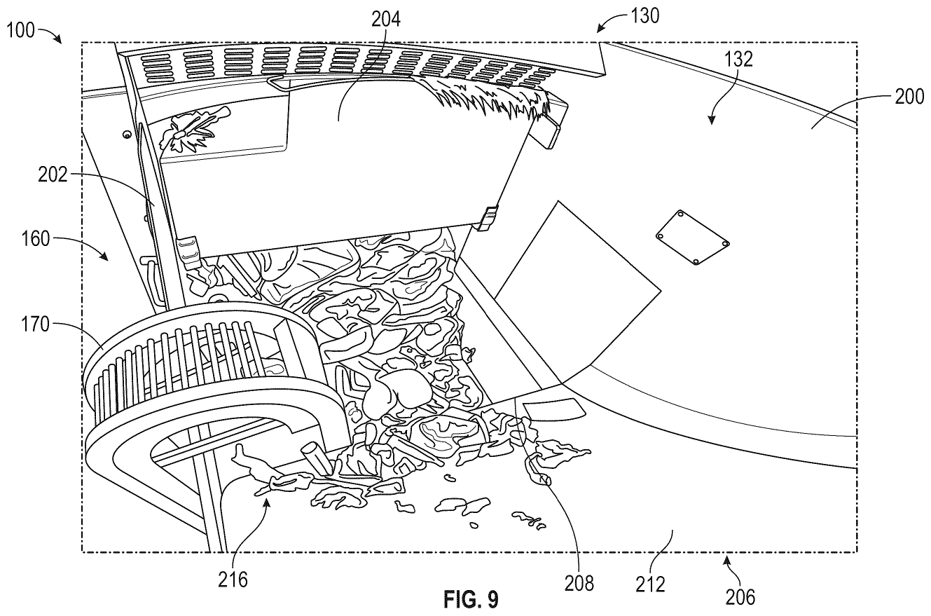

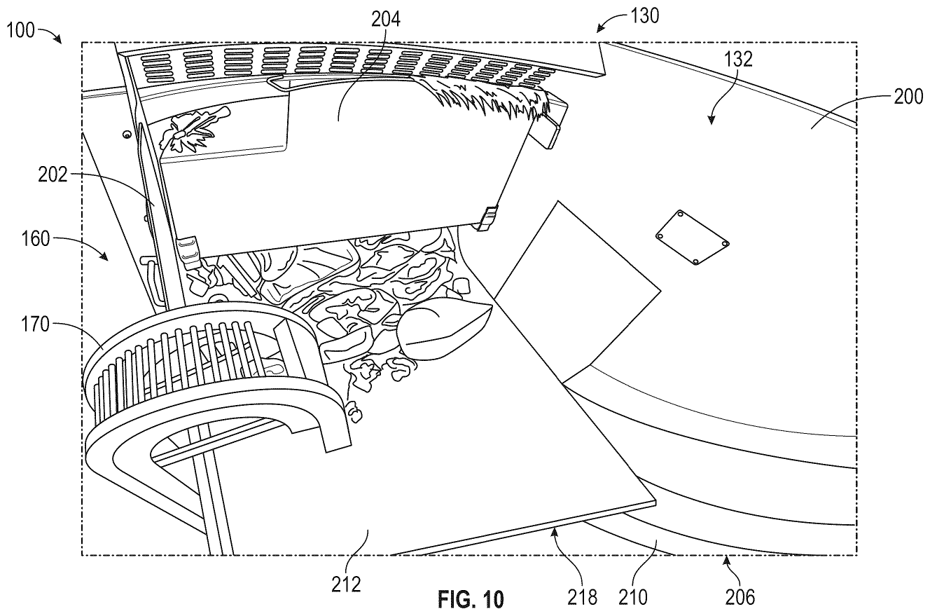

In general, the refuse vehicles 100 illustrated in FIGS. 3-8 can be equipped with a packing input (e.g., a button, a switch, a joystick, a soft key on a display, etc.) that is configured to automatically initiate a packing procedure where refuse is packed within the hopper volume 132. The packing procedure gradually extends a pack panel toward a packing position and then back to a retracted position. FIGS. 9 and 10 illustrate an exemplary embodiment of the refuse compartment 130 of the side-loading refuse vehicle 100. As shown in FIGS. 9 and 10, the hopper volume 132 is an internal volume of the refuse compartment 130 and is defined by a left sidewall 200, a right sidewall 202, a holding plate 204, and a packing assembly 206. The left sidewall 200 extends longitudinally (e.g., in a direction extending between the cab 40 and the tailgate 136) between the holding plate 204 and the packing assembly 206. The lifting assembly 160 is arranged on the right sidewall 202, and the holding plate 204 extends downwardly (e.g., in a direction toward the chassis 20, or in a direction perpendicular to the ground on which the vehicle 100 travels) from a top wall of the refuse compartment 130. In general, the holding plate 204 separates the hopper volume 132 and the storage volume 134 and forms a partition between the two sections in the refuse compartment 130. In addition, the holding plate 204 aids in preventing refuse being packed into the storage volume 134 from falling back toward the hopper volume 132.

With reference to FIGS. 9-13, the packing assembly 206 includes a pack panel 208, a ramped or curved wall 210, a pivot or follower plate 212, and a packing actuator 214. The pack panel 208 is arranged generally vertically (e.g., in a direction perpendicular to a road on which the vehicle 100 travels) and faces in a direction toward the storage volume 134 (e.g., a normal extending from the outer surface of the pack panel 208 is directed toward the storage volume 134). A first end 216 of the pivot plate 212 is rotatably coupled to a distal end of the pack panel 208 so that the pivot plate 212 rotates relative to the pack panel 208 as the pack panel 208 moves between retracted and extended positions. A second end 218 of the pivot plate 212 is configured to engage and slide along the curved wall 210 (e.g., when the pack panel 208 is in a position where the second end 218 of the pivot plate 212 overlaps with the curved wall 210). The curved wall 210 defines a generally curved profile that ramps downwardly in a direction toward the storage volume 134.

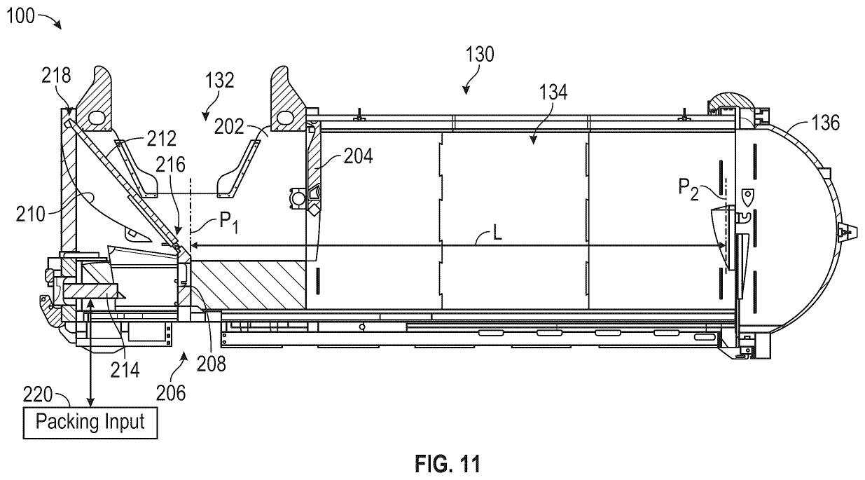

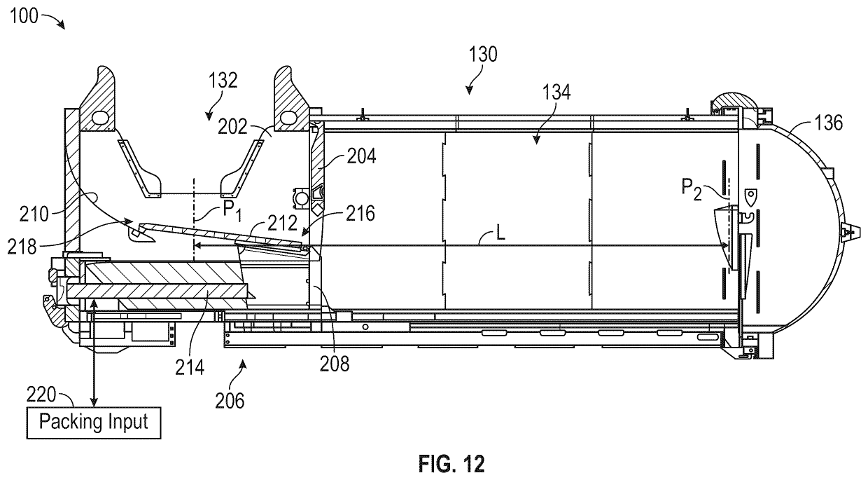

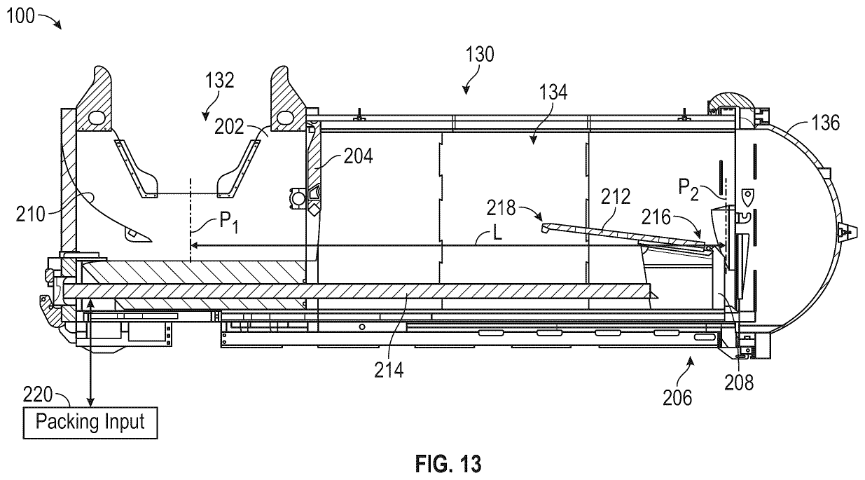

The pack panel 208 is coupled to the packing actuator 214 so that the packing actuator 214 selectively moves the pack panel 208 between a retracted or home position (see, e.g., FIGS. 9 and 11), a packing position (see, e.g., FIGS. 10 and 12), an extended or eject position (see, e.g., FIG. 13), and any position in between the extended position and the retracted position. In some embodiments, the packing actuator 214 is a telescoping actuator that is pneumatically, hydraulically, electronically, or electro-hydraulically driven.

A packing procedure generally includes moving the pack panel 208 from the retracted position (see, e.g., FIGS. 9 and 11) to a packing position where the pack panel 208 is at least partially extended from the retracted position in a direction toward the extended position (see, e.g., FIGS. 10 and 12). In the retracted position, the pack panel 208 is arranged at least partially within the hopper volume 132, and the packing procedure extends the pack panel 208 toward the storage volume 134 to compact and displace refuse in the hopper volume 132 in a direction toward the storage volume 134. The pack panel 208 is then retracted from the packing position to the retracted position. The process of extending the pack panel 208 from the retracted position, to the packing position, and then back to the retracted position may be repeated a predefined number of times during the packing procedure (e.g., one time, two times, three times, or continuously until the packing actuator 214 is instructed to stop the packing procedure). The packing procedure enables the hopper volume 132 to be repeatedly filled and packed until the storage volume 134 is full and an ejection procedure is required (see, e.g., FIG. 13).

The ejection procedure generally includes moving the pack panel 208, via the packing actuator 214, to the extended or eject position (see, e.g., FIG. 13). During the ejection procedure, the tailgate 136 is opened and the pack panel 208 is moved to the extended position and refuse in the storage volume 134 is ejected. The movement of the pack panel 208 between the retracted position and the extended position defines a travel length or distance of the pack panel 208. For example, in the retracted position, the pack panel 208 defines an initial plane P1 and, in the extended position, the pack panel 208 defines a final plane P2. A length L is defined between the initial plane P1 and the final plane P2 and represents a travel distance traversed by the pack panel 208 between the retracted and extended positions.

In some embodiments, the packing procedure is initiated or triggered by a packing input 220. In some embodiments, the packing input 220 is arranged within the cab interior 42. In some embodiments, the packing input 220 is in the form of a button, a switch, a joystick, a soft key on a display, or an equivalent input that is capable of being manually activated by a user of the vehicle 100. The packing input 220 is configured to automatically initiate a the packing procedure in response to activation of the packing input 220 (e.g., a user manually pressing the packing input 220). The position of the pack panel 208 is automatically controlled and predefined during the packing procedure, as described herein. In some embodiments, the packing input 220 is not a physical component and the packing procedure is automatically triggered or initiated by a controller (e.g., the controller 240) in response to (e.g., directly or indirectly in response to) one or more inputs.

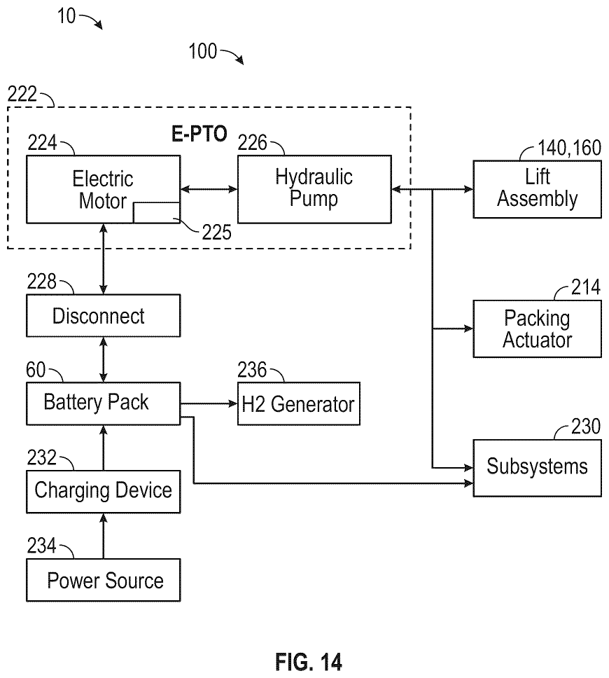

Referring to FIG. 14, in embodiments in which the refuse vehicle 100 is an electric refuse vehicle (e.g., an E-refuse vehicle, etc.) or a hybrid refuse vehicle (e.g., a vehicle including both electric and hydraulic power systems, etc.), the refuse vehicle 100 may further include an onboard energy storage device (e.g., battery pack 60). In some embodiments, the onboard energy storage device includes the battery pack 60 that provides power to a motor that produces rotational power to drive the refuse vehicle 100. The energy storage device is also used to provide power to different subsystems on the refuse vehicle 100 (e.g., pumps, controllers, lights, displays, electric actuators, etc.). The refuse vehicle 100 may also include an electric power take-off (E-PTO) system, shown as E-PTO system 222, that is configured to receive electrical power from the battery pack 60 and/or other power sources and to convert the electrical power to mechanical and/or hydraulic power for different subsystems on the refuse vehicle 100. In some embodiments, the E-PTO system 222 receives electrical power from the energy storage device and provides the electrical power to an electric motor 224. In such embodiments, the electric motor 224 may drive a hydraulic pump 226 that provides pressurized hydraulic fluid to different vehicle subsystems 230, such as the lift assembly 140, the lift assembly 160, the packer/ejector, shown as the packing actuator 214, or other subsystems (e.g., the tailgate actuator 138, etc.).

The E-PTO system 222 may include an E-PTO controller 225. The E-PTO controller 225 may monitor various systems within the refuse vehicle, including the E-PTO system 222. The E-PTO controller 225 may receive data from sensors (not shown) within the system, compare the data to expected values under normal operating conditions, adjust the operation parameters of components of the system, and determine if a critical operating condition exists based on the sensor data. Further, the E-PTO controller 225 may shut down the system and/or the refuse vehicle 100 in response to detecting a critical operating condition. In some embodiments, the refuse vehicle 100 further includes a disconnect 228 positioned between the battery pack 60 and the E-PTO system 222 to allow different vehicle subsystems (e.g., the packing actuator 214, the lift assembly 140, the lift assembly 160, etc.) to be decoupled and de-energized from the electrical power source.

The battery pack 60 may include one or more batteries such as one or more rechargeable batteries. The battery cells can be rechargeable lithium-ion battery cells, for example. The battery pack 60 is configured to supply electrical power to the electric motor 224, which powers the hydraulic pump 226. The battery pack 60 can also supply electrical power to additional subsystems 230 on the refuse vehicle 100, including additional electric motors, cab controls (e.g., climate controls, steering, lights, etc.), pumps, controllers, lights, displays, electric actuators, and/or auxiliary systems, for example.

The battery pack 60 may be charged by consumption of fuel onboard the refuse vehicle 100. In an exemplary embodiment, the battery pack 60 is charged by a charging device 232 that receives electrical power from a power source 234. The charging device 232 may be in the form of a battery charger, an alternator, power electronics (e.g., inverters, rectifiers, etc.), and/or other electronic components that facilitate provided DC power to the battery pack 60 for charging. The power source 234 may be in the form of an internal combustion engine that powers the refuse vehicle 100. The internal combustion engine may combust fuels such as, hydrogen, renewable natural gas (RNG), compressed natural gas (CNG), diesel, gasoline, eFuels, synthetic fuels, etc., and mechanical energy generated by the internal combustion engine is converted into electrical energy by the charging device 232 to charge the battery pack 60. In some embodiments, the power source 234 is in the form of a fuel cell that converts fuel (e.g., hydrogen) into electrical energy that is supplied to the charging device 232 to charge the battery pack 60. In embodiments where the refuse vehicle 100 includes a fuel cell, the refuse vehicle 100 may also include a hydrogen generator 236 (e.g., H2 generator) that is powered by the battery pack 60 and produces hydrogen, for example, via electrolysis, a proton exchange membrane, etc.

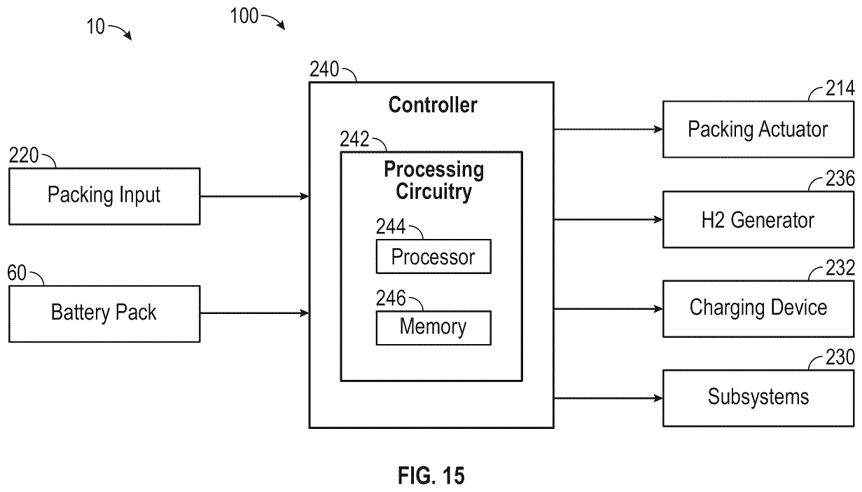

As shown in FIG. 15, the vehicle 100 includes a controller 240 in communication with the packing input 220, the battery pack 60, the packing actuator 214, the different vehicle subsystems 230, the charging device 232, and the hydrogen generator 236. In some embodiments, the controller 240 is a native controller on the vehicle 100 that communicates over a vehicle CAN bus. In some embodiments, the controller 240 is a dedicated controller that is included on the vehicle to control operations of the packing input 220, the battery pack 60, the packing actuator 214, the different vehicle subsystems 230, the charging device 232, and the hydrogen generator 236. The controller 240 includes a processing circuit 242 having a processor 244 and memory 246. The processing circuit 242 can be communicably connected to a communications interface such that the processing circuit 242 and the various components thereof can send and receive data via the communications interface. The processor 244 can be implemented as a general purpose processor, an application specific integrated circuit (“ASIC”), one or more field programmable gate arrays (“FPGAs”), a group of processing components, or other suitable electronic processing components.

The memory 246 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. The memory 246 can be or include volatile memory or non-volatile memory. The memory 246 can include database components, object code components, script components, or any other type of information structure for supporting the various activities and information structures described in the present application. According to some embodiments, the memory 246 is communicably connected to the processor 244 via the processing circuit 242 and includes computer code for executing (e.g., by the processing circuit 242 and/or the processor 244) one or more processes described herein.

In general, the controller 240 is configured to receive one or more battery parameters (e.g., state of charge, voltage, maximum cell voltage, minimum cell voltage, etc.) from the battery pack 60 (e.g., from a battery management system of the battery pack 60) and control one or more components of the refuse vehicle 100 (e.g., the battery pack 60, the packing actuator 214, the different vehicle subsystems 230, the charging device 232, and the hydrogen generator 236) based on the one or more battery parameters. For example, the controller 240 is configured to receive or monitor a state of charge from the battery pack 60 and control the one or more components of the refuse vehicle 100 based on the value of the state of charge. Specifically, the controller 240 is configured to determine if the state of charge satisfies a lower threshold or satisfies an upper threshold. If the state of charge of the battery pack 60 does not satisfy the lower threshold or the upper threshold, then the state of charge of the battery pack 60 is within a desired operating range (e.g., between about 20% and about 80%) and the controller 240 operates the components of the refuse vehicle 100 according to normal operation or a normal operating mode. In general, the normal operating mode does not alter the intended function or operation of the components of the refuse vehicle 100 that are powered by the battery pack 60. For example, in the normal operating mode, the battery pack 60 supplies electrical power to the hydraulic pump 226 to operate, without limitation or derating, the various hydraulic components of the refuse vehicle 100 (e.g., the tailgate actuator 138, the lift assembly 140, 160, the packing actuator 214), and to the other subsystems 230.

The lower threshold for state of charge is defined to prevent or inhibit the battery pack 60 from reaching a state of charge where significant voltage drop off occurs. In some embodiments, the controller 240 is configured to determine that the state of charge satisfies the lower threshold when the state of charge is less than or equal to a lower threshold value. In some embodiments, the controller 240 is configured to determine that the state of charge satisfies the lower threshold when the state of charge is within a predefined tolerance of the lower threshold value (e.g., within about 20%, about 15%, about 10%, or about 5%). Regardless of the specific trigger for satisfying the lower threshold, when the controller 240 determines that the state of charge of the battery pack 60 satisfies the lower threshold, the controller 240 is configured to limit function operation on the refuse vehicle 100 and initiate a charging procedure for the battery pack 60.

In some embodiments, the controller 240 is configured to limit function operation by preventing or inhibiting operation of the packing actuator 214. The packing actuator 214 and the packing procedure demand a significant amount of power from the battery pack 60, for example, when compared to the other functions/components powered by the battery pack 60. Accordingly, by preventing operation of the packing actuator 214 when the lower threshold is satisfied, the battery pack 60 is guarded against being significantly discharged when already at a lower state of charge. In some embodiments, when the lower threshold is satisfied, the controller 240 is configured to restrict the battery pack 60 to only supply electrical power to components with low power consumption. For example, the controller 240 may limit the battery pack 60 to supply power to a low-power subset of the subsystems 230 (e.g., cab controls (climate controls, steering, lights, etc.), controllers, lights, displays, etc.).

In addition to limiting function operation, the controller 240 is configured to initiate the charging procedure when the lower threshold is satisfied. In some embodiments, the charging procedure includes combusting fuel with the power source 234 to convert mechanical energy into electrical energy that is supplied to the battery pack 60 via the charging device 232. In some embodiments, the power source 234 is a fuel cell that supplies electrical energy to the charging device 232. Regardless of the particular implements of the power source 234, the charging device 232 supplies the battery pack 60 with electrical power during the charging procedure until a state of charge of the battery pack 60 is greater than or equal to an upper charging threshold. Once the state of charge of the battery pack 60 reaches the upper charging threshold, the controller 240 is configured to resume the normal operating mode and allow operation of the packing actuator 214 and the packing procedure.

The upper threshold for state of charge is defined to prevent or inhibit the battery pack 60 from reaching a state of charge where an operating lifetime of the battery pack 60 degrades and/or where energy recapture is limited or prevented (e.g., regenerative braking). In some embodiments, the controller 240 is configured to determine that the state of charge satisfies the upper threshold when the state of charge is less than or equal to an upper threshold value. In some embodiments, the controller 240 is configured to determine that the state of charge satisfies the upper threshold when the state of charge is within a predefined tolerance of the upper threshold value (e.g., within about 20%, about 15%, about 10%, or about 5%). Regardless of the specific trigger for satisfying the upper threshold, when the controller 240 determines that the state of charge of the battery pack 60 satisfies the upper threshold, the controller 240 is configured to initiate a discharge procedure.

In some embodiments, the discharge procedure includes the controller 240 instructing the packing actuator 214 to initiate the packing procedure. As described herein, the packing actuator 214 demands a significant amount of power during the packing procedure, so initiating the packing procedure when the upper threshold is satisfied helps to discharge the battery pack 60 to below the upper threshold value. In some embodiments, the controller 240 is configured to continuously run the packing procedure until the state of charge of the battery pack 60 reaches a lower charge threshold. In some embodiments, the controller 240 is configured to increase a frequency that the packing procedure is performed along a particular route for the refuse vehicle 100. For example, the controller 240 is configured to operate the packing actuator 214 and perform the packing procedure after a predetermined number of stops or pickup cycles (e.g., 2 stops, 3 stops, 4 stops, etc.) and, during the discharge procedure, the controller 240 is configured to decrease the number of stops or pickup cycles between subsequent packing procedures (e.g., if 4 stops during normal operation, decrease to 3 stops, or 2 stops, or 1 stop), which increases the frequency that the packing actuator 214 is operated and aids in discharging the battery pack 60.

Alternatively or additionally, the discharge procedure includes the controller 240 instructing the hydrogen generator 236 to produce hydrogen, which also aids in discharging the battery pack 60. Regardless of the particular operation that is performed to discharge the battery pack 60 during the discharge procedure, the controller 240 is configured to continue the discharge procedure until the state of charge of the battery pack 60 is less than or equal to the lower charging threshold.

In general, the battery management control provided by monitoring the state of charge of the battery pack 60 and altering the energy generation and function performance on the refuse vehicle 10 aids in maintaining the battery pack 60 within the desired operating range, which improves the operating efficiency and operating lifetime of the battery pack 60. Additionally, the battery management control both prevents operation of the packing actuator 214 at lower states of charge, and encourages the use of the packing actuator 214 at higher states of charge to provide performance improvements for continuous charging and maximize operating efficiency of the battery pack 60.

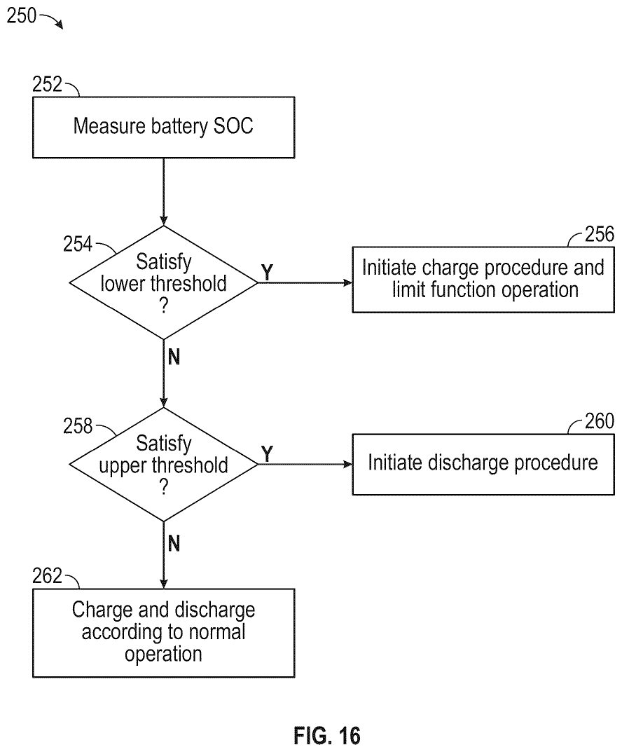

FIG. 16 shows an exemplary embodiment of a battery management method 250 for a refuse vehicle (e.g., the refuse vehicle 100). In some embodiments, the battery management method 250 is performed by a controller (e.g., the controller 240). The battery management method 250 initiates at step 252 where a state of charge of the battery pack 60 is measured or monitored. In some embodiments, the state of charge is provided to the controller 240 by a battery management system. In some embodiments, the state of charge is directly measured by the controller 240. After the state of charge is measured at step 252, the controller 240 determines, at step 254, if the measured state of charge satisfies a lower threshold. In some embodiments, the controller 240 is configured to determine that the state of charge satisfies the lower threshold when the state of charge is less than or equal to a lower threshold value. In some embodiments, the controller 240 is configured to determine that the state of charge satisfies the lower threshold when the state of charge is within a predefined tolerance of the lower threshold value (e.g., within about 20%, about 15%, about 10%, or about 5%).

If the controller 240 determines, at step 254, that the measured state of charge satisfies the lower threshold, then the controller 240 is configured to initiate, at step 256, a charge procedure and limit function operation. In some embodiments, the charging procedure includes combusting fuel with the power source 234 to convert mechanical energy into electrical energy that is supplied to the battery pack 60 via the charging device 232. In some embodiments, the power source 234 is a fuel cell that supplies electrical energy to the charging device 232. Regardless of the particular implements of the power source 234, the charging device 232 supplies the battery pack 60 with electrical power during the charging procedure until a state of charge of the battery pack 60 is greater than or equal to an upper charging threshold.

In some embodiments, the controller 240 is configured to limit function operation, at step 256, by preventing or inhibiting operation of the packing actuator 214. In some embodiments, when the lower threshold is satisfied, the controller 240 is configured to limit function operation by restricting the battery pack 60 to only supply electrical power to components with low power consumption. For example, the controller 240 may limit the battery pack 60 to supply power to a low-power subset of the subsystems 230 (e.g., cab controls (climate controls, steering, lights, etc.), controllers, lights, displays, etc.).

If the controller 240 determines, at step 254, that the measured state of charge does not satisfy the lower threshold, then the controller 240 is configured to determine at, step 258, if the measured state of charge satisfies an upper threshold. In some embodiments, the controller 240 is configured to determine that the state of charge satisfies the upper threshold when the state of charge is less than or equal to an upper threshold value. In some embodiments, the controller 240 is configured to determine that the state of charge satisfies the upper threshold when the state of charge is within a predefined tolerance of the upper threshold value (e.g., within about 20%, about 15%, about 10%, or about 5%).

If the controller 240 determines, at step 258, that the measured state of charge satisfies the upper threshold, then the controller 240 is configured to initiate a discharge procedure at step 260. In some embodiments, the discharge procedure, at step 260, includes the controller 240 instructing the packing actuator 214 to initiate the packing procedure. In some embodiments, the controller 240 is configured to continuously run the packing procedure until the state of charge of the battery pack 60 reaches a lower charge threshold. In some embodiments, the controller 240 is configured to increase a frequency that the packing procedure is performed along a particular route for the refuse vehicle 100. Alternatively or additionally, the discharge procedure, at step 262, includes the controller 240 instructing the hydrogen generator 236 to produce hydrogen, which also aids in discharging the battery pack 60. Regardless of the particular operation that is performed to discharge the battery pack 60 during the discharge procedure, the controller 240 is configured to continue the discharge procedure until the state of charge of the battery pack 60 is less than or equal to the lower charging threshold.

If the controller 240 determines, at step 258, that the measured state of charge does not satisfy the upper threshold, the controller 240 enables, at step 262, the battery pack 60 to be charged and discharged according to the normal operating mode at step 262. If the measured state of charge does not satisfy both the lower threshold and the upper threshold, then the controller 240 determines that the measured state of charge is within the desired operating range and allows normal operation. The method 250 is continuously performed during operation of the refuse vehicle 100, which enables the controller 240 to selectively vary component operation (e.g., in response to the state of charge satisfying the lower threshold or the upper threshold), so that the state of charge of the battery pack 60 is encouraged to stay within or near the desired operating range and the packing actuator 214 is utilized most often at high states of charge.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members, or the two members and any additional intermediate members being integrally formed as a single unitary body with one another or with the two members or the two members and any additional intermediate members being attached to one another.

References herein to the positions of elements (e.g., “top,” “bottom,” “above,” etc.) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the refuse vehicle as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present disclosures. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A battery management system for a refuse vehicle, comprising:
a battery pack; and
a controller in communication with the battery pack and a packing actuator of the refuse vehicle, wherein the controller is configured to:
receive a state of charge of the battery pack;
determine if the state of charge satisfies a lower threshold;
in response to determining that the state of charge satisfies the lower threshold, prevent operation of the packing actuator;
determine if the state of charge satisfies an upper threshold; and
in response to determining that the state of charge satisfies the upper threshold, initiate operation of the packing actuator.

2. The battery management system of claim 1, wherein the controller is configured to determine that the state of charge satisfies the lower threshold when the state of charge is less than or equal to a lower threshold value.

3. The battery management system of claim 1, wherein the controller is configured to determine that the state of charge satisfies the lower threshold when the state of charge is within a predefined tolerance of a lower threshold value.

4. The battery management system of claim 1, wherein the controller is configured to determine that the state of charge satisfies the upper threshold when the state of charge is greater than or equal to an upper threshold value.

5. The battery management system of claim 1, wherein the controller is configured to determine that the state of charge satisfies the upper threshold when the state of charge is within a predefined tolerance of an upper threshold value.

6. The battery management system of claim 1, wherein the controller is configured to:
in response to determining that the state of charge satisfies the lower threshold, initiate a charging procedure for the battery pack.

7. The battery management system of claim 6, wherein the charging procedure includes converting mechanical energy from an internal combustion engine into electrical energy and supplying the electrical energy to the battery pack with a charging device.

8. The battery management system of claim 6, wherein the charging procedure includes supplying electrical energy from a fuel cell to the battery pack.

9. A battery management system for a refuse vehicle, comprising:
a battery pack; and
a controller in communication with the battery pack, wherein the controller is configured to:
receive a state of charge of the battery pack;
determine if the state of charge satisfies a lower threshold;
in response to determining that the state of charge satisfies the lower threshold, initiate a charging procedure for the battery pack and limit function operation for the refuse vehicle;
determine if the state of charge satisfies an upper threshold; and
in response to determining that the state of charge satisfies the upper threshold, initiate a discharge procedure for the battery pack.

10. The battery management system of claim 9, wherein the charging procedure includes converting mechanical energy from an internal combustion engine of the refuse vehicle into electrical energy and supplying the electrical energy to the battery pack with a charging device.

11. The battery management system of claim 9, wherein the charging procedure includes supplying electrical energy from a fuel cell to the battery pack.

12. The battery management system of claim 9, wherein the controller is configured to limit function operation by preventing operation of a packing actuator of the refuse vehicle.

13. The battery management system of claim 9, wherein the discharge procedure includes initiating operation of a packing actuator of the refuse vehicle.

14. The battery management system of claim 9, wherein the discharge procedure includes increasing a frequency that a packing actuator of the refuse vehicle performs a packing operation.

15. The battery management system of claim 9, wherein the controller is configured to determine that the state of charge satisfies the lower threshold when the state of charge is less than or equal to a lower threshold value.

16. The battery management system of claim 9, wherein the controller is configured to determine that the state of charge satisfies the lower threshold when the state of charge is within a predefined tolerance of a lower threshold value.

17. The battery management system of claim 9, wherein the controller is configured to determine that the state of charge satisfies the upper threshold when the state of charge is greater than or equal to an upper threshold value.

18. The battery management system of claim 9, wherein the controller is configured to determine that the state of charge satisfies the upper threshold when the state of charge is within a predefined tolerance of an upper threshold value.

19. A refuse vehicle comprising:
a chassis;
a refuse compartment supported on the chassis;
a lift assembly;
a packing actuator movable between a retracted position and an extended position;
a battery pack; and
a controller in communication with the battery pack, the lift assembly, and the packing actuator, wherein the controller is configured to:
receive a state of charge of the battery pack;
determine if the state of charge satisfies a lower threshold;
in response to determining that the state of charge satisfies the lower threshold, prevent operation of the packing actuator;
determine if the state of charge satisfies an upper threshold; and
in response to determining that the state of charge satisfies the upper threshold, initiate operation of the packing actuator.

20. The refuse vehicle of claim 19, wherein the controller is configured to:
in response to determining that the state of charge satisfies the lower threshold, initiate a charging procedure for the battery pack, wherein the charging procedure includes converting mechanical energy from an internal combustion engine into electrical energy and supplying the electrical energy to the battery pack with a charging device, or supplying electrical energy from a fuel cell to the battery pack.
